(19) United States
(12) Patent Application Publication
(10) Pub. No.: US 2010/0214510 A1
(43) Pub. Date: Aug. 26, 2010

(54) BACKLIGHT UNIT AND LIQUID CRYSTAL DISPLAY DEVICE

(76) Inventor: Yasumori Kuromizu, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/682,647

(22) PCT Filed: May 27, 2008
(86) PCT No.: PCT/JP2008/059711

§ 371 Date: Apr. 12, 2010

(30) Foreign Application Priority Data
Dec. 10, 2007 (JP) 2007-266275

(51) Int. Cl. G02F 1/1335; G09F 13/08

(52) U.S. Cl. 349/67; 362/97.2

(57) ABSTRACT

A backlight unit 77 includes a fluorescent tube 1, a backlight chassis 3 and a reflective sheet 4. The reflective sheet 4 is subjected to adjustment processing such that a high-brightness side of a brightness difference in the reflected light in the Y direction is brought close to a low-brightness side of the brightness difference.

### TECHNICAL FIELD

The present invention relates to a backlight unit that supplies light to a liquid crystal display panel, and to a liquid crystal display device that is provided with the backlight unit.

### BACKGROUND ART

It is common that backlight units supplying light to a liquid crystal display panel are provided with a fluorescent tube as a light source (for example, Patent Document 1). In Patent Document 1, a backlight unit is disclosed that emits light from a single fluorescent tube via a light guide plate and an optical sheet (such as a diffusion sheet).

Recent backlight units, however, are not limited to a backlight unit as described above; they have a plurality of fluorescent tubes (linear light sources) laid to spread over in a backlight chassis so that direct-above light of those fluorescent tubes is supplied via an optical sheet to a liquid crystal display panel.

### Patent Document 1: JP-A-2006-339043

### DISCLOSURE OF THE INVENTION

### Problems to be Solved by the Invention

However, between a fluorescent tube and a backlight chassis (a housing chassis) formed of metal, air—an insulator—exists. Thus, a capacitor is formed between the fluorescent tube and the backlight chassis. When such a capacitor is formed, part of a current that passes through the fluorescent tube leaks and, attributable to the leaked current, the amount of light emitted from the fluorescent tube decreases.

In particular, when the fluorescent tube emit light under application of a voltage from one end thereof, attributable to leakage current, a current fed over the entire region of the fluorescent tube is not constant, resulting in different light emission amounts on the high-voltage side and on the low-voltage side. As a result, a difference occurs in the amount of reflected light from a reflective sheet laid between the fluorescent tube and the backlight chassis.

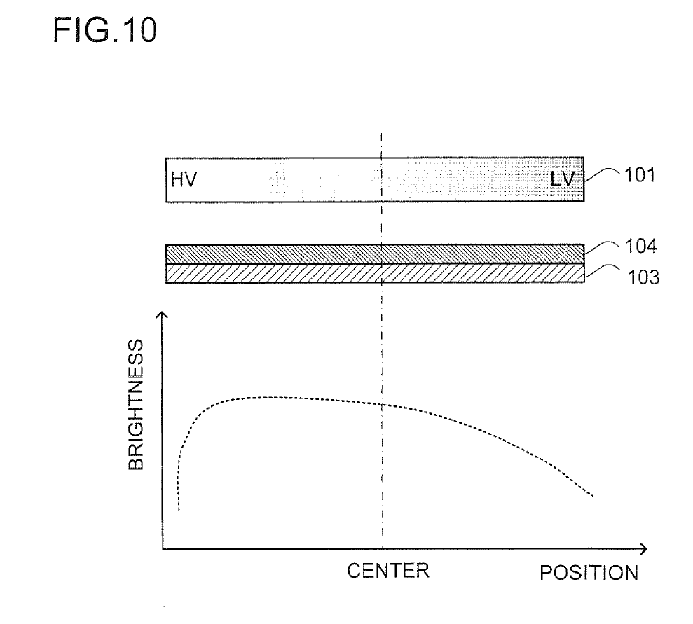

To be specific, as shown in FIG. 10 (a diagram illustrating the positional relationship between a fluorescent tube 101, a reflective sheet 104, and a backlight chassis 103, and the brightness corresponding to a position in the fluorescent tube 101 in the longitudinal direction thereof), the brightness of the fluorescent tube 101 at the high-voltage HV side is high compared with that of the fluorescent tube 101 at the low-voltage LV side, thus causing uneven brightness in backlight from a backlight unit.

The present invention has been devised under the above background. An object of the invention is to provide a backlight unit etc. in which uneven brightness is alleviated.

### Means for Solving the Problem

A backlight unit comprises: a linear light source extending in a first direction; a housing chassis housing the linear light source; and a light reflective member located in the housing chassis and changing part of light from the linear light source into reflected light. In the backlight unit, the light reflective member is subjected to adjustment processing. The adjustment processing is performed to bring the high-brightness side of a brightness difference in the reflected light in the first direction close to the low-brightness side of the brightness difference.

Generally, part of light from the linear light source is dependent on the shape of the linear light source, and thus reaches the light reflective member in a linear shape. The brightness of the reached light is not uniform over the entire region, and a difference may occur. For example, a brightness difference may occur between the light at one end of the linear shape and that at the other end thereof.

In such a case, if an ordinary light reflective member reflects the reached light, a brightness difference may occur also in that reflected light. Specifically, the reflected light includes a brightness difference in the first direction, i.e. the direction in which the linear light source extends (the linear direction). The adjustment processing is performed such that the high-brightness side of the brightness difference is brought close to the low-brightness side thereof.

As an example, the adjustment processing is performed to form, in the light reflective member, an open hole portion for exposing one face of the housing chassis that has a lower reflectivity than the light reflective member.

This allows the light reflective member and the one face of the housing chassis exposed via the open hole portion to reflect light from the linear light source. Thus, if high brightness light is made to reach the housing chassis and low brightness light is made to reach the light reflective member, the high brightness light becomes low brightness by being reflected by the housing chassis of low reflectivity and the low brightness light remains unchanged (the brightness is maintained) by being reflected by the light reflective member of high reflectivity. As a result, the reflected light is likely to have even brightness in the first direction, i.e. the direction in which the linear light source extends.

Desirably, the open hole portion comprises a plurality of open hole portions that are provided close to one another to form a group, and the group (an open hole group) forms a line. In this way, it is possible for the open hole group to efficiently adjust the brightness with respect to the light that advances linearly from the linear light source. Moreover, if the open hole portions are located directly below the linear light source, i.e., if the open hole group is covered by the linear light source, light reaches the housing chassis surely via the open hole group, and thus the brightness adjustment is performed further efficiently.

Moreover, it is desirable that the distribution density of the open hole portions vary continuously along the first direction, i.e. the linear direction, of the linear light source (for example, the linear shape of the open hole group). In this way, in a part with a high distribution density, a large amount of the floor face of the housing chassis are exposed through the reflective sheet, and, in a part with a low distribution density, only a small amount of the floor face of the housing chassis is exposed through the reflective sheet. Thus, in accordance with the exposure of the floor face of the housing chassis in the reflective sheet, the reflectivity varies continuously along the linear shape. This allows the brightness adjustment to be performed smoothly.

The distribution density of the open hole portions is not limited to varying continuously along the first direction of the linear light source, but it may, for example, vary continuously along a second direction intersecting with respect to the first direction of the linear light source (for example, in a case where linear light sources are arrayed in parallel, the direction in which the linear light sources are arrayed in parallel).

The continuous variation of the reflectivity along the linear shape in accordance with the exposure of the floor face of the housing chassis in the reflective sheet does not occur only when the distribution density of the open hole portions varies continuously. As an example, the reflectivity varies continuously along the line shape also when the open area of the open hole portions varies continuously along the first direction of the linear light source (for example, along the linear shape of the open hole group). This, however, is not meant to be any limitation; the open area of the open hole portions may vary continuously along the second direction of the linear light source.

In the backlight unit, it is desirable that, in at least a part between the light reflective member and the housing chassis, a reflectivity suppressing member be laid that has a lower reflectivity than either of the light reflective member and the housing chassis.

This permits the floor face of the housing chassis and the reflectivity suppressing member to be exposed through the light reflective member. The light from the linear light source is therefore reflected by members having different reflectivities, namely the floor face of the housing chassis, the reflectivity suppressing member, and the light reflective member. This offers variations in the amount of reflected light and hence increased flexibility in the brightness adjustment.

There is no particular limitation to the material of the reflectivity suppressing member; examples of the material include metal, resin, a coating, and the like.

There is no particular limitation also to the shape of the open hole portion; it may be circular or polygonal.

Preferably, as the open hole portion, a plurality of them are formed, and they are arranged in a zigzag or lattice pattern.

There is no particular limitation to the way the open hole portion is formed. For example, the open hole portion is preferably formed by punching the light reflective member or by plotter cutting the light reflective member. In addition, the open hole portion is preferably formed by laser processing the light reflective member.

A liquid crystal display device comprising: the backlight unit described above; and a liquid crystal display panel that receives light emitted from the backlight unit can also be said to be the present invention.

### Advantages of the Invention

According to the present invention, light from a linear light source is reflected by members having various reflectivities, and thus the amount of reflected light varies. Thus, even if there is a brightness difference in the light from the linear light source, that brightness difference (uneven brightness) is eliminated by adjusting the amount of reflected light.

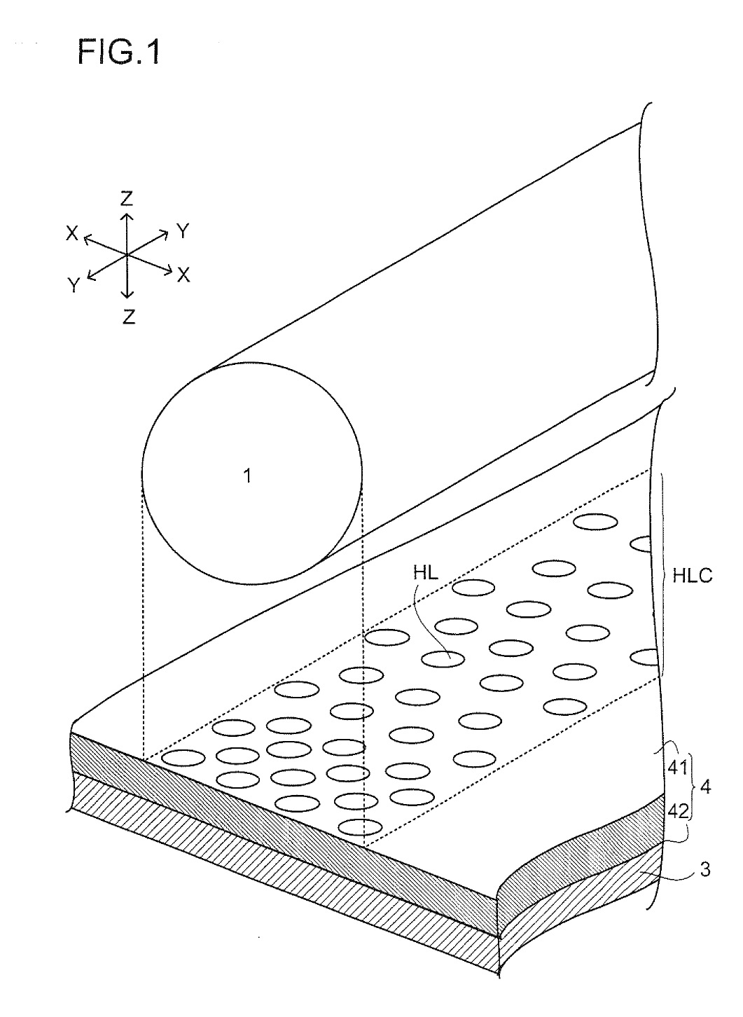

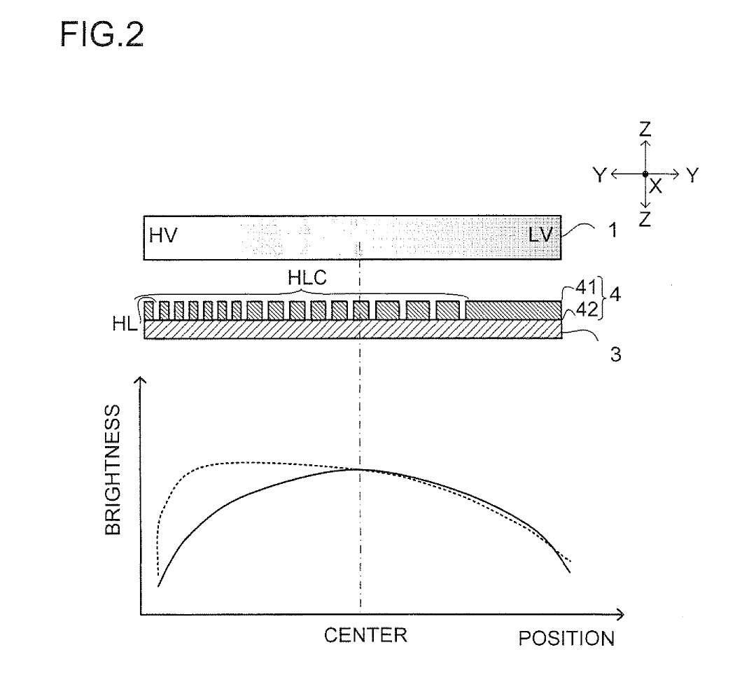

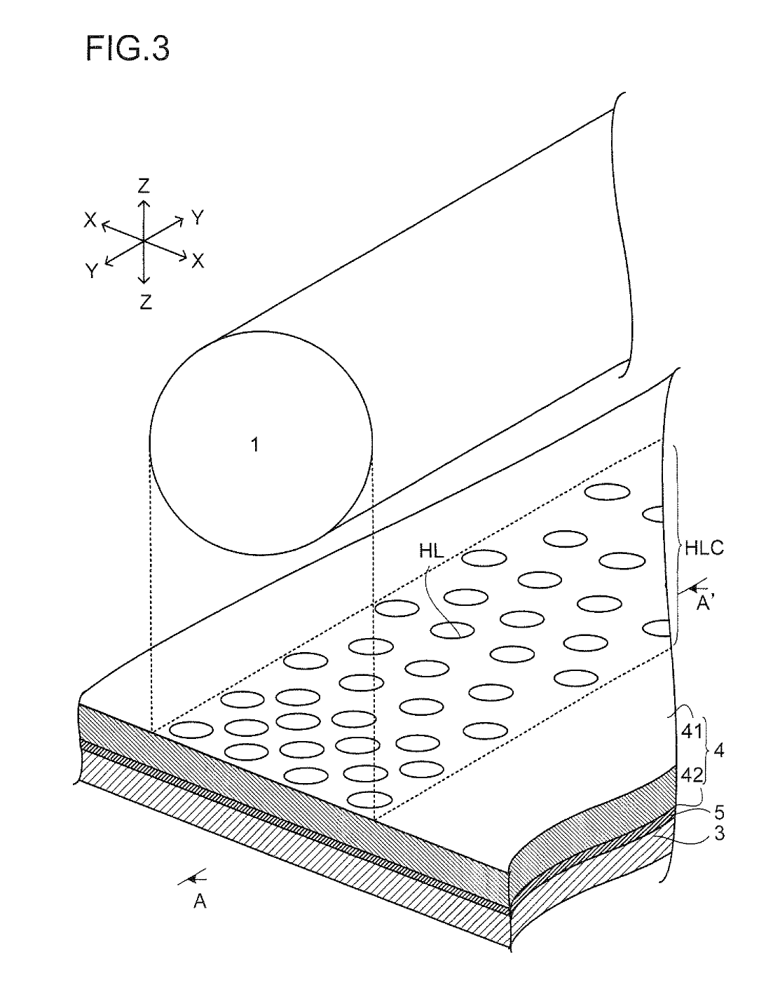

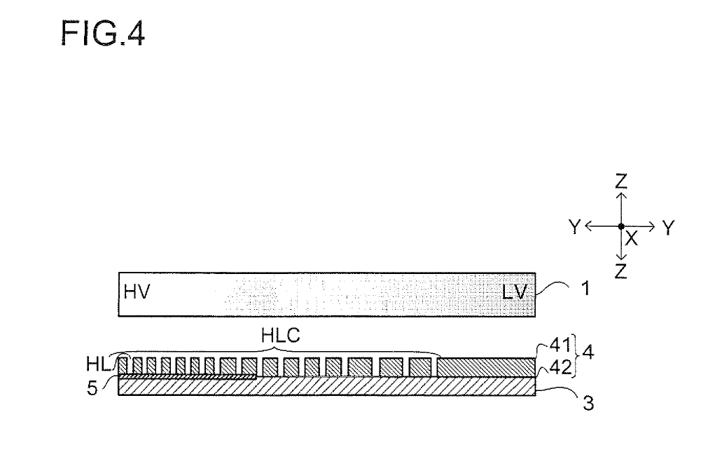

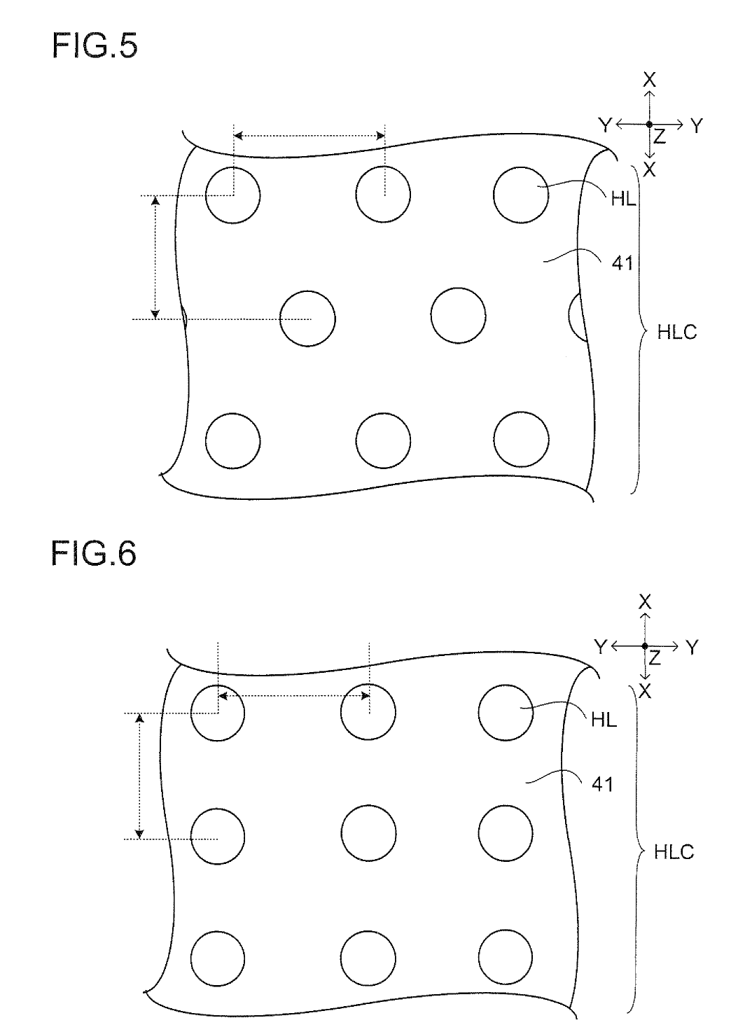

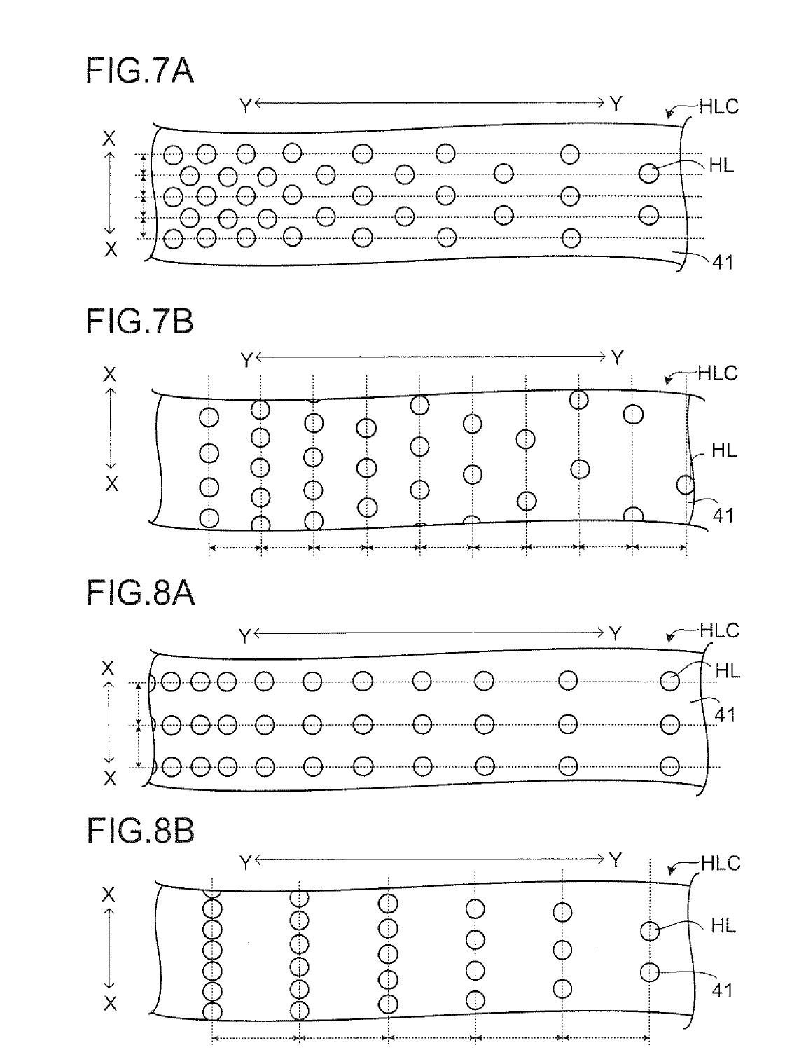

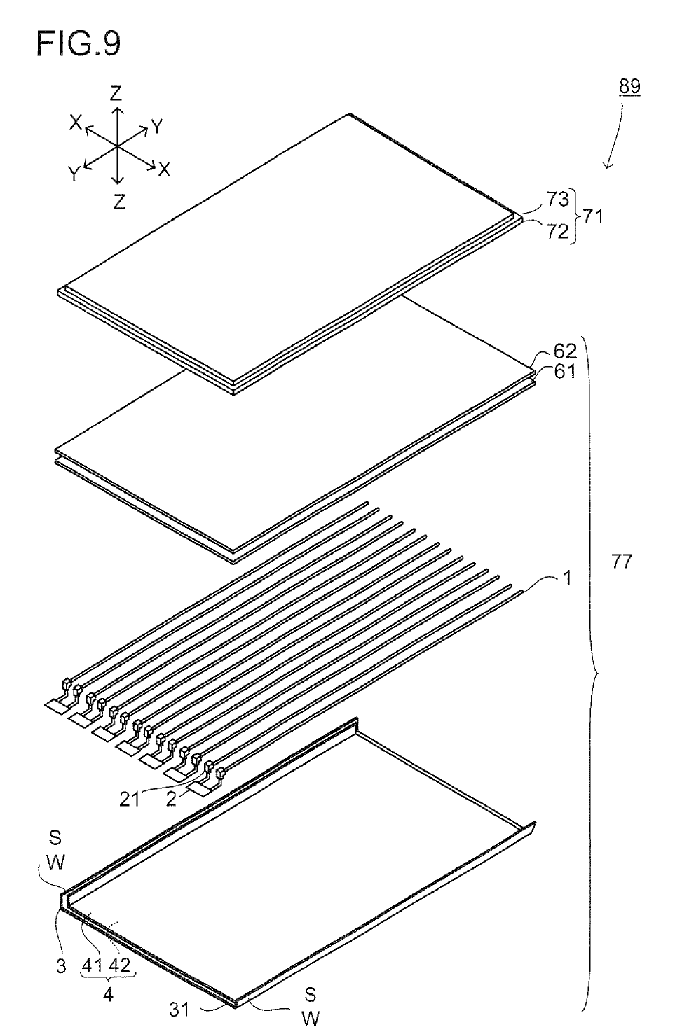

### BRIEF DESCRIPTION OF DRAWINGS

[FIG. 1] An enlarged view of a part in FIG. 9 showing a fluorescent tube, a reflective sheet, and a backlight chassis.

[FIG. 2] A diagram illustrating the positional relationship between the fluorescent tube, the reflective sheet, and the backlight chassis in the backlight unit, and the brightness corresponding to a position in the fluorescent tube in the longitudinal direction thereof.

[FIG. 3] An enlarged view of another example of FIG. 1.

[FIG. 4] A cross sectional view taken along line A-A′ in FIG. 3.

[FIG. 5] A plan view showing a zigzag arrangement of open holes.

[FIG. 6] A plan view showing a lattice arrangement of the open holes.

[FIG. 7A] A plan view showing a zigzag arrangement in which a space between open holes along the Y direction varies.

[FIG. 7B] A plan view showing a zigzag arrangement in which a space between open holes along the X direction varies.

[FIG. 8A] A plan view showing a lattice arrangement in which a space between open holes along the Y direction varies.

[FIG. 8B] A plan view showing a lattice arrangement in which a space between open holes along the X direction varies.

[FIG. 9] An exploded perspective view of a liquid crystal display device.

[FIG. 10] A diagram illustrating the positional relationship between a fluorescent tube, a reflective sheet, and a backlight chassis in a conventional backlight unit, and the brightness corresponding to a position in the fluorescent tube in the longitudinal direction thereof.

### LIST OF REFERENCE SYMBOLS

1 fluorescent tube (linear light source)

2 inverter board

3 backlight chassis

31 floor face of the backlight chassis

4 reflective sheet (light reflective member)

41 reflective face of the reflective sheet

42 non-reflective face of the reflective sheet

HL open hole

HLC open hole group

5 light absorbing sheet (reflectivity suppressing member)

61 diffusion sheet

62 lens sheet

71 liquid crystal display panel

77 backlight unit

89 liquid crystal display device

X direction in which fluorescent tubes are arrayed (second direction)

Y direction in which the fluorescent tube extends (first direction)

Z direction perpendicular to both the X and Y directions.

### BEST MODE FOR CARRYING OUT THE INVENTION

### First Embodiment

A first embodiment of the present invention will be described below with reference to the relevant drawings. It should be noted that there may be a case where hatching, a reference numeral of a member, or the like may be omitted for the sake of convenience, in which case another diagram will be referred to. Note also that a solid black circle on a drawing means a direction perpendicular to the plane of the figures.

An exploded perspective view of FIG. 9 shows a liquid crystal display device 89. The liquid crystal display device 89 includes a liquid crystal display panel 71 and a backlight unit 77.

In the liquid crystal display panel 71, an active matrix substrate 72 that includes a switching device such as a TFT (thin film transistor) and an opposing substrate 73 that opposes the active matrix substrate 72 are stuck together with a sealing material (unillustrated). In addition, a gap between the two substrates 72 and 73 is filled with liquid crystal (unillustrated).

The liquid crystal display panel 71 is a display panel of a non-luminous type, and therefore receives light (backlight) from the backlight unit 77 and converts that light into image light to emit.

The backlight unit 77 emitting light includes a fluorescent tube 1, an inverter board 2, a backlight chassis 3, a reflective sheet 4, a diffusion sheet 61, and a lens sheet 62.

The fluorescent tube (a linear light source) 1 is linear (bar-shaped, cylindrical, or the like), and, in the backlight chassis 3, as the fluorescent tube 1, a plurality of them are provided to be laid side by side (note that, for the sake of convenience, only some of them are shown in the diagram).

The type of the fluorescent tube 1 is not limited; it may be, for example, a cold cathode tube or hot cathode tube. In the following description, the direction in which the fluorescent tubes 1 are arrayed will be referred to as the X direction (a second direction), the direction in which the fluorescent tubes 1 extend will be referred to as the Y direction (a first direction), and the direction perpendicular to both the X and Y directions will be referred to as the Z direction.

The inverter hoard 2 is a circuit board for allowing a current fed from an unillustrated inverter to pass through the fluorescent tube 1. The inverter board 2 is fitted with a socket 21 corresponding to a fluorescent tube 1. Accordingly, by being fitted to the socket 21, the fluorescent tube 1 receives current supply.

The backlight chassis (a housing chassis) 3 is a housing member, which is enclosed by opposing outer walls SW and a floor face 31, for housing various members such as the fluorescent tubes 1. There is no particular limitation to the material of the backlight chassis 3, and examples include a galvanized steel plate.

The reflective sheet (a light reflective member) 4 is a reflective member that, on one hand, covers the floor face 31 and the outer walls SW of the backlight chassis 3 and, on the other hand, is covered by the fluorescent tubes 1. Thus, the reflective sheet 4 reflects light from the fluorescent tubes 1. To be specific, the reflective sheet 4 reflects part of radial light (light radiating from the fluorescent tubes 1) emitted from the fluorescent tubes 1 and leads it to an open face of the backlight chassis 3.

The diffusion sheet 61 is so located as to cover the fluorescent tubes 1. The diffusion sheet 61 receives light from the fluorescent tubes 1 and disperses (diffuses) it. That is, when light from the fluorescent tubes 1 enters the diffusion sheet 61, that light is dispersed and diffused so that it pervades in the in-plane direction.

The lens sheet 62 is a sheet having, for example, a lens shape in the sheet face thereof so as to deflect (converge) the radiation characteristic of light, and is so located as to cover the diffusion sheet 61. When light that has advanced from the diffusion sheet 61 enters the lens sheet 62, that light converges and improves the light emission brightness per unit area.

In the backlight unit 77 as described above, light from the fluorescent tubes 1 reaches the diffusion sheet 61 directly or via the reflective sheet 4, and in addition passes through the lens sheet 62 while being diffused so that it is emitted as backlight with enhanced light emission brightness. This backlight then reaches the liquid crystal display panel 71, and the liquid crystal display panel 71 displays an image.

The reflective sheet 4 will now be described in detail. As shown in FIG. 1—an enlarged view of FIG. 9—, the reflective sheet 4 includes open hole portions HL. The open hole portions HL are holes penetrating the reflective sheet 4 from a reflective face (an obverse face) 41 to a non-reflective face (a reverse face) 42.

At the reflective face 41 side, a fluorescent tube 1 is located, and on the non-reflective face 42 side, the floor face 31 of the backlight chassis 3 is located. That is, the reflective sheet 4 is laid between the fluorescent tube 1 and the backlight chassis 3. Thus, the open hole portions HL of the reflective sheet 4 allows the light from the fluorescent tube 1 to reach the floor face (one face) 31 of the backlight chassis 3.

This generates two kinds of light, namely the light reflected by the floor face 31 of the backlight chassis 3 and the light reflected by the reflective face 41 of the reflective sheet 4. When the reflectivity of the floor face 31 in the backlight chassis 3 and that of the reflective face 41 in the reflective sheet 4 are different, attributable to the difference between those reflectivities (the difference in the amount of reflected light), the brightnesses of the two kinds of light differ. Thus, by use of the two kinds of light, it is possible to adjust the brightness of the light (backlight).

For example, in a case where part of a current passing through the fluorescent tube 1 leaks attributable to a capacitor formed by air between the fluorescent tube 1 and the backlight chassis 3, when a high voltage HV is applied to one end of the fluorescent tube 1, a current fed over the entire region of the fluorescent tube 1 is not constant. This causes a brightness difference.

To be specific, at an end of the fluorescent tube 1 where the high voltage HV is applied, though the leakage current is large, a relatively high current supply is received due to the high voltage HV, and thus high brightness light is emitted. By contrast, at an end of the fluorescent tube 1 where a low voltage LV is applied, though the leakage current is small, a relatively low current supply is received due to the low voltage LV, and thus low brightness light is emitted.

That is, the brightness near the end of the fluorescent tube 1 where the high voltage HV is applied is high compared with that near the other end of the fluorescent tube 1 (where the low voltage LV is applied). In addition, being dependent on the brightness difference in the fluorescent tube 1, the reflected light from the reflective sheet 4 also includes a brightness difference (difference in the intensity of brightness) in the direction in which the fluorescent tube 1 extends.

Thus, the light near the end of the fluorescent tube 1 where the high voltage HV is applied is made to reflect, via the open hole portions HL, at the floor face 31 of the backlight chassis 3 having a lower reflectivity than the reflective face 41 of the reflective sheet 4. On the other hand, the light near the end of the fluorescent tube 1 where the low voltage LV is applied is made to reflect at the reflective face 41 of the reflective sheet 4 having a higher reflectivity than the floor face 31 of the backlight chassis 3.

This allows a reflected light amount near the end of the fluorescent tube 1 where the high voltage HV is applied—a high-brightness side—to be suppressed by the floor face 31 of the backlight chassis 3 of low reflectivity. Thus, the brightness near the end of the fluorescent tube 1 where the high voltage HV is applied becomes low as shown in FIG. 2 (a diagram illustrating the positional relationship between the fluorescent tube, the reflective sheet 4, and the backlight chassis 3, and the brightness corresponding to a position in the fluorescent tube 1 in the longitudinal direction thereof).

Specifically, the high-brightness side of the brightness difference in the reflected light in the Y direction is brought close to the brightness near the end of the fluorescent tube 1 where the low voltage LV is applied—a low-brightness side—. (See a solid line in FIG. 2. A dotted line indicates a comparative example in which the high-voltage HV side is high brightness, and “CENTER” means the center position of the fluorescent tube 1.)

In particular, as shown in FIG. 1, it is preferable that the open hole portions HL be provided close to one another to form a group (an open hole group HLC). Furthermore, the group preferably has a shape such that it is covered by the fluorescent tube 1, i.e., has a linear shape along the direction (the Y direction) in which the fluorescent tube 1 extends (preferably, the open hole portions HL are located directly below the fluorescent tube 1).

This allows the light from the fluorescent tube 1 (in particular, the light formed into the same shape as the linear shape of the fluorescent tube 1) to reach the floor face 31 of the backlight chassis 3 efficiently via the open hole portions HL. This makes it easier for the two kinds of light to generate, namely the light reflected by the floor face 31 of the backlight chassis 3 and the light reflected by the reflective face 41 of the reflective sheet 4.

It is not absolutely required that the open hole group HLC be covered by the fluorescent tube 1. That is, the open hole group HLC may not be covered by the fluorescent tube 1. The reason is that, so long as the linear direction of the open hole group HLC is parallel with the direction in which the fluorescent tube 1 extends, the light formed into the same shape as the linear shape of the fluorescent tube 1 tends to reach the open hole group HLC. It should be noted, however, that if the open hole group HLC is covered by the fluorescent tube 1, the open hole group HLC is not reflected in the backlight and thus is not notable.

Moreover, it is preferable that, in the linear open hole group HLC, the distribution density of the open hole portions HL vary continuously along the linear shape of the open hole group HLC (preferably, a gradation is formed by the open hole portions HL).

This allows the amount of light that advances from the floor face 31 of the backlight chassis 3 via the open hole group HLC to vary continuously along the linear shape of the open hole group HLC, and thus brightness adjustment is performed continuously (smoothly).

For example, it is assumed that the distribution density of the open hole portions HL gradually decreases from the end of the fluorescent tube 1 where the high voltage HV is applied to the end of the fluorescent tube 1 where the low voltage LV is applied. Then, part of the light emitted from the fluorescent tube 1, which has a relatively high brightness due to the high voltage HV is changed into light that is reflected by the floor face 31 of the backlight chassis 3 via a large quantity of open hole portions HL and light that is reflected by the reflective sheet 4 having a relatively small area because of the presence of the large quantity of open hole portions HL. Thus, the reflected light amount near the end of the fluorescent tube 1 where the high voltage HV is applied is suppressed, and the brightness is lowered.

On the other hand, part of the light emitted from the fluorescent tube 1, which has a relatively low brightness due to the low voltage LV, is changed into light that is reflected by the floor face 31 of the backlight chassis 3 via a small quantity of open hole portions HL and light that is reflected by the reflective sheet 4 having a relatively large area because of the presence of the small quantity of open hole portions HL. Thus, the reflected light amount near the end of the fluorescent tube 1 where the low voltage LV is applied is not suppressed, and the brightness is maintained. As a result, the brightness in the direction in which the fluorescent tube 1 extends is balanced (uneven brightness is alleviated).

### Second Embodiment

A second embodiment of the invention will be described. Such members having a similar function as those used in the first embodiment are identified with common reference numerals and symbols, and no description of them will be repeated.

In the first embodiment, the backlight unit 77 is subjected to processing (adjustment processing) such that the open hole portions HL are formed in the reflective sheet 4. The open hole portions HL expose, through the reflective sheet 4, the floor face 31 of the backlight chassis 3 having a lower reflectivity than the reflective sheet 4. Thus, part of the light from the fluorescent tube 1 is changed into light that is reflected by the reflective sheet 4 of high reflectivity and light that is reflected by the floor face 31 of the backlight chassis 3 of low reflectivity. Thus, in the backlight unit 77 in the first embodiment, brightness adjustment is performed by adjusting the exposure of the floor face 31 of the backlight chassis 3 in the reflective sheet 4.

However, there are only two types of members for reflecting the light from the fluorescent tube 1, namely the reflective sheet 4 and the floor face 31 of the backlight chassis 3. In this embodiment, a description will be therefore given of a backlight unit 77 including a new reflective member.

As shown in FIG. 3 and FIG. 4 (a cross sectional view taken along line A-A′ in

FIG. 3), in the backlight unit 77, in at least a part between the reflective sheet 4 and the floor face 31 of the backlight chassis 3, there is laid a black-colored light absorbing sheet (a low reflective sheet) 5 having a lower reflectivity than the floor face 31 of the backlight chassis 3.

To be specific, it is not required that the light absorbing sheet (a reflectivity suppressing member) 5 be located in the entire region between the reflective sheet 4 and the floor face 31 of the backlight chassis 3 so long as it is located in a part, between the reflective sheet 4 and the floor face 31 of the backlight chassis 3, that corresponds to near the end of the fluorescent tube 1 where the high voltage HV is applied—where it is likely to have high brightness—.

This allows the floor face 31 of the backlight chassis 3 and the light absorbing sheet 5 to be exposed through the reflective sheet 4 via the open hole portions HL. Thus, the light from the fluorescent tube 1 is reflected by three members (the reflective sheet 4, the floor face 31 of the backlight chassis 3, and the light absorbing sheet 5) having different reflectivities. This makes it easier to perform brightness adjustment that is dependent on the reflected light amount.

For example, even if the brightness near the end of the fluorescent tube 1 where the high voltage HV is applied is not sufficiently lowered with the reflectivity of the floor face 31 of the backlight chassis 3, provision of the light absorbing sheet 5 such that it is exposed, through the reflective sheet 4, in a part corresponding to near that end of the fluorescent tube 1 makes it possible to sufficiently decrease the brightness.

The light absorbing sheet is generally formed of a colored resin (for example, a black-colored polyethylene terephthalate). This, however, is not meant to be any limitation. For example. a coat such as a colored coating may serve as the light absorbing sheet 5.

### Other Embodiments

It should be understood that the present invention may be carried out in any manner other than specifically described above as embodiments, and many modifications and variations are possible within the scope and spirit of the present invention.

For example, in a case where the amount of light advancing from the floor face 31 of the backlight chassis 3 via the open hole group HLC is made to vary continuously along the linear shape of the open hole group HLC, it is possible to make it vary by other than the distribution density of the open hole portions HL. As an example, the open area of the open hole portions HL may vary continuously along the Y or X direction of the fluorescent tube 1 {for example, the open area of the open hole portions HL may vary continuously along the linear shape of the open hole group HLC, or may vary continuously in the direction intersecting (orthogonal to, or the like) that linear shape}.

The shape of the open hole portions HL may be circular or polygonal. However, if there is an edge in the open hole portions HL, it is reflected in the backlight; thus, a shape without an edge is desirable, for example, a true circle.

As shown in FIGS. 5 and 6, in the open hole group HLC, the open hole portions HL may be provided close to one another in a zigzag arrangement or in a lattice arrangement. Examples of the zigzag arrangement are shown in FIGS. 7A and 7B. In addition, examples of the lattice arrangement are shown in FIGS. 8A and 8B.

To be specific, in cases of FIGS. 7A and 8A, although the space between open hole portions HL and HL in the X direction is constant, with the space between the open hole portions HL and HL along the Y direction—the direction intersecting the X direction—being changed (to be dense or sparse), the distribution density of the open hole portions HL varies. On the other hand, in cases of FIGS. 7B and 8B, although the space between open hole portions HL and HL in the Y direction is constant, with the space between the open hole portions HL and HL along the X direction—the direction intersecting the Y direction—being changed, the distribution density of the open hole portions HL varies.

In either case, the distribution density of the open hole portions HL varies continuously along the linear direction of the open hole group HLC (the Y direction of the fluorescent tube 1). Thus, brightness adjustment is possible. In the case of the lattice arrangement, however, the open hole portions HL are arranged linearly. For example, in the case of FIG. 8A, the open hole portions HL are arranged in the Y direction, and in the case of FIG. 8B, the open hole portions HL are arranged in the X direction. Thus, the arranged open hole portions HL may be reflected in backlight. From the viewpoint of avoiding such reflection, a zigzag arrangement as shown in FIG. 7A or 7B is desirable.

It should be noted that the direction in which the distribution density of the open hole portions HL varies continuously is not limited to the Y direction of the fluorescent tube 1; it may vary continuously along the X direction of the fluorescent tube 1. Moreover, the open hole portions HL may be provided in a zigzag or lattice arrangement with the open area varied continuously.

It is not required that the open hole portions HL be so provided as to correspond to the entire region of the fluorescent tube 1. For example, if the light near one end of the fluorescent tube 1 where the low voltage LV is applied has low brightness and thus reflection by the floor face 31 of the backlight chassis 3 is not required, the open hole portions HL may not be formed in a part of the reflective sheet 4, which corresponds to near that end of the fluorescent tube 1 (see FIG. 2).

There is no particular restriction on the way the open hole portions HL are formed. For example, the open hole portions may be formed by punching the reflective sheet 4, or by plotter cutting the reflective sheet 4. Moreover, the open hole portions HL may be formed by laser processing the reflective sheet 4.

1. A backlight unit comprising:
a linear light source extending in a first direction;
a housing chassis housing the linear light source; and
a light reflective member located in the housing chassis and changing part of light from the linear light source into reflected light,
wherein the light reflective member is subjected to adjustment processing such that a high-brightness side of a brightness difference in the reflected light in the first direction is brought close to a low-brightness side of the brightness difference.

2. The backlight unit according to claim 1,
wherein, in the adjustment processing, there is formed, in the light reflective member, an open hole portion for exposing one face of the housing chassis that has a lower reflectivity than the light reflective member.

3. The backlight unit according to claim 2,
wherein the open hole portion comprises open hole portions provided close to one another to form a group, and the group forms a line.

4. The backlight unit according to claim 3,
wherein the open hole portions are located directly below the linear light source.

5. The backlight unit according to claim 3,
wherein a distribution density of the open hole portions varies continuously along the first direction of the linear light source.

6. The backlight unit according to claim 3,
wherein the distribution density of the open hole portions varies continuously along a second direction intersecting with respect to the first direction of the linear light source.

7. The backlight unit according to claim 3,
wherein an open area of the open hole portions varies continuously along the first direction of the linear light source.

8. The backlight unit according to claim 3,
wherein the open area of the open hole portions varies continuously along the second direction intersecting with respect to the first direction of the linear light source.

9. The backlight unit according to claim 2,
wherein, in at least a part between the light reflective member and the housing chassis, there is laid a reflectivity suppressing member having a lower reflectivity than either of the light reflective member and the housing chassis.

10. The backlight unit according to claim 9,
wherein the reflectivity suppressing member is metal, resin, or a coating.

11. The backlight unit according to claim 2,
wherein a shape of the open hole portion is circular or polygonal.

12. The backlight unit according to claim 3,
wherein, as the open hole portion, a plurality of open hole portions are formed and arranged in a zigzag pattern.

13. The backlight unit according to claim 3,
wherein, as the open hole portion, a plurality of open hole portions are formed and arranged in a lattice pattern.

14. The backlight unit according to claim 2,
wherein the open hole portion is formed by punching the light reflective member.

15. The backlight unit according to claim 2,
wherein the open hole portion is formed by plotter cutting the light reflective member.

16. The backlight unit according to claim 2,
wherein the open hole portion is formed by laser processing the light reflective member.

17. A liquid crystal display device comprising:
the backlight unit according to claim 1; and
a liquid crystal display panel receiving light emitted from the backlight unit.
